(19) United States
(12) Patent Application Publication
(10) Pub. No.: US 2003/0018842 A1
(43) Pub. Date: Jan. 23, 2003

(54) Interrupt controller

(76) Inventor: Donald Harbin, Scottsdale, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/908,770

(22) Filed: Jul. 19, 2001

(51) Int. Cl. G06F 9/48

(52) U.S. Cl. 710/260

(57) ABSTRACT

Disclosed are a system and method of processing interrupt signals. An interrupt signal may be received from one of a plurality of interrupt sources. The received interrupt signal may be associated with a memory address of an interrupt service routine. The memory address of the interrupt service routine may be stored in a second memory. Instructions stored in the second memory may then be executed in response to the interrupt signal.

### BACKGROUND

1. Field

The subject matter disclosed herein relates to processing systems. In particular, the subject matter disclosed herein relates to processing systems which respond to interrupts.

2. Information

Real-time embedded processing systems typically execute instruction code sequences in processing cycles in response to interrupt requests from external processes. Such requests typically require a timely and predictable response from the embedded processing system. Therefore, there is a desire to provide such processing systems that execute tasks while making efficient use of processing cycles. This is particularly significant in embedded processing systems which control input/output functions such as the storage and retrieval of data from a storage system or a network.

A real-time embedded processing system typically receives requests from external processes in the form of interrupt signals generated by one or more interrupt sources. In response to an interrupt signal, the embedded processing system typically executes an interrupt service routine or interrupt handler to satisfy the underlying request. Where the embedded processing system receives interrupt signals from more than one interrupt source, the embedded processing system typically executes a routine to associate an interrupt source with an interrupt service routine and then executes an instruction sequence for the associated interrupt service routine stored in a memory.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a processing platform according to an embodiment of the present invention.

FIG. 2 shows a schematic diagram of an interrupt controller according to an embodiment of the processing platform shown in FIG. 1.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise a sequence of instructions which are interpretable by a processor for executing one or more operations on one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise processing circuitry in combination with machine-executable instructions stored in a memory. However, these are merely examples of structures which may provide logic and embodiments of the present invention are not limited in this respect.

A “processing system” as discussed herein relates to a combination of hardware and software resources for accomplishing computational tasks. However, this is merely an example of a processing system and embodiments of the present invention are not limited in this respect. A “host processing system” relates to a processing system which may be adapted to communicate with a “peripheral device.”For example, a peripheral device may provide inputs to or receive outputs from an application process hosted on the host processing system. However, these are merely examples of a host processing system and a peripheral device, and embodiments of the present invention are not limited in these respects.

A “data bus” as referred to herein relates to circuitry for transmitting data between devices. For example, a data bus may transmit data between a host processing system and a peripheral device. However, this is merely an example of a data bus and embodiments of the present invention are not limited in this respect. A “bus transaction” as referred to herein relates to an interaction between or among devices coupled in a data bus structure wherein one device transmits data addressed to one or more other devices through the data bus structure. However, this is merely an example of a bus transaction and embodiments of the present invention are not limited in this respect.

An “interrupt signal” as referred to herein relates to a signal to inform a process on a processing system that a certain event has occurred or condition exists. In response to an interrupt signal, a processing system may take a specified action. For example, a processing system may temporarily suspend execution of a process to respond to the associated event or condition. However, these are merely examples of an interrupt signal and embodiments of the present invention are not limited in these respects.

An “interrupt source” as referred to herein relates to a process or device which initiates an interrupt signal in response to detecting an event or condition. For example, an interrupt source may be coupled to a processing system to assert an interrupt signal detectable at the processing system. Such an interrupt source may assert the interrupt signal in response to detection of an event or condition associated with the interrupt source. However, this is merely an example of an interrupt source and embodiments of the present invention are not limited in this respect.

An “interrupt signal type” as referred to herein relates to a classification of interrupt signals which may be received at a processing system. For example, a processing system may receive interrupt signals asserted by multiple interrupt sources where interrupt signals from an particular interrupt source is associated with an interrupt signal type. However, this is merely an example of an interrupt signal type and embodiments of the present invention are not limited in this respect.

A “memory” as referred to herein relates to a system for storing data in a retrievable format. For example, a memory may comprise a machine-readable medium comprising an array of memory locations for storing data. Such a memory location may be associated with a “memory address” to enable retrieval of data stored at the memory location. However, these are merely examples of a memory and memory address, and embodiments of the present invention are not limited in these respects.

An “interrupt service routine” or “interrupt handler” as referred to herein relates to a process which may be executed by a processing system to take action in response to assertion of an interrupt signal. For example, a processing system may execute an interrupt service routine or interrupt handler from instructions which are stored in a memory at an “interrupt service routine memory address.” Accordingly, in response to assertion of an interrupt signal, a processing system may suspend execution of a current task and commence the sequential execution of instructions beginning with an instruction located at the interrupt service routine memory address. However, these are merely examples of an interrupt service routine or an interrupt handler, and embodiments of the present invention are not limited in these respects.

An “interrupt vector” as referred to herein relates to a data structure comprising a pointer to an interrupt service routine stored in a memory. For example, an interrupt vector may comprise an interrupt service routine memory address stored in a predetermined location in a memory. An interrupt vector may be associated with a particular interrupt signal type such that a processor may locate or “jump” to an associated interrupt service routine in response to an interrupt signal of the particular interrupt signal type. However, these are merely examples of an interrupt vector and embodiments of the present invention are not limited in these respects.

Briefly, an embodiment of the present invention relates to a system and method of processing interrupt signals. An interrupt signal may be received from one of a plurality of interrupt sources. The interrupt source may be associated with an interrupt service routine memory address and the interrupt service routine memory address may then be stored in a memory location accessible by a processor. The processor may then execute instructions stored at the interrupt service routine memory address in response to the interrupt signal. However, this is merely an example embodiment and other embodiments of the present invention are not limited in these respects.

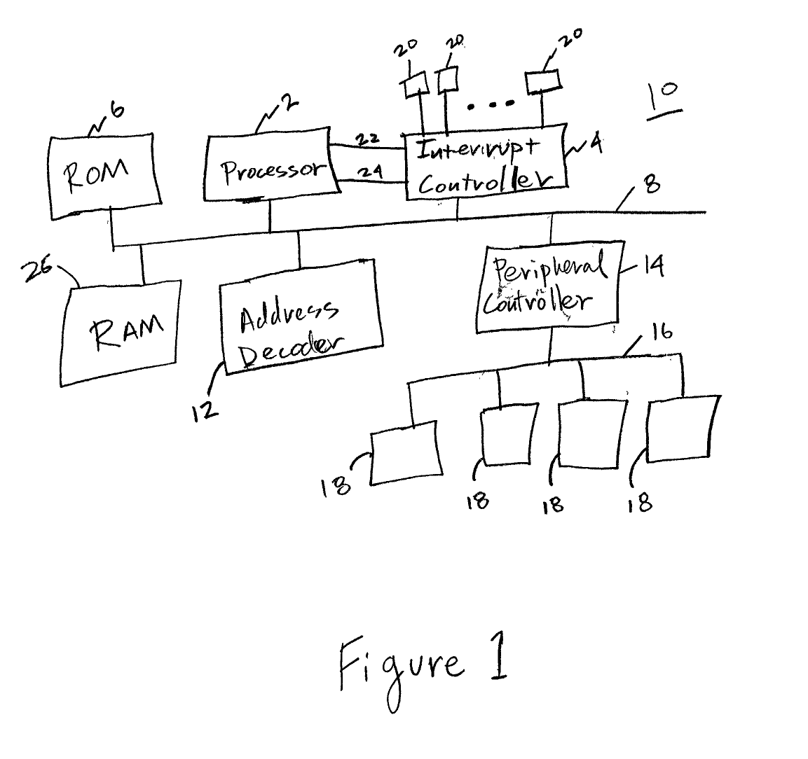

FIG. 1 shows a schematic diagram of a processing platform 10 according to an embodiment of the present invention. A processor 2 is coupled to a read only memory (ROM) 6, interrupt controller 4, random access memory (RAM) 26, an address decoder 12 and peripheral controller 14 through a system bus 8. The processor 2 may be any one of several processors capable of responding to interrupt signals including, for example, an ARM processor or i960® processor sold by Intel Corporation. However, these are merely examples of processors which are capable of responding to interrupt signals and embodiments of the present invention are not limited in this respect. The system bus 8 may comprise any one of several data bus architectures which may be processor specific such as, for example, system bus architectures which are compatible with the ARM processor or i960® processor sold by Intel Corporation. However, these are merely examples of a system bus which may be used in a processing platform and embodiments of the present invention are not limited in these respects.

In the illustrated embodiment, a device residing on the system bus 8 may be adapted to receive a “chip enable” signal from the address decoder 12 which enables the device to send data to or receive data from another device residing on the system bus 8. For example, the address decoder 12 may detect data being transmitted on the system bus 8 which is addressed to a particular device on the system bus 8. The address decoder 12 may then assert a chip enable signal to the particular device such that the particular device may receive the message. However, this is merely an example of how data may be directed to particular devices on a data bus and embodiments of the present invention are not limited in this respect.

In the illustrated embodiment, a device residing on the system bus 8 may attempt to retrieve data from a memory device such as the RAM 26 by initiating a bus transaction on the system bus 8 where the initiating device asserts address lines on the system bus 8 to indicate a memory address of the data to be retrieved. The address decoder 12 may then assert a chip enable signal to the RAM 26 to enable retrieval of data from a memory address associated with a memory location in the RAM 26. However, this is merely an example of how data may be retrieved from a memory in response to a bus transaction and embodiments of the present invention are not limited in this respect.

According to an embodiment the interrupt controller 4 may receive interrupt signals from a plurality of interrupt sources 20. Such interrupt sources may include, for example, input/output devices such as controllers for a Small Computer System Interface (SCSI) (established by the National Committee for Information Technology Standards) or interfaces for network adapters, hard drives, modems or Ethernet devices. However, these are merely examples of an interrupt source and embodiments of the present invention are not limited in these respects.

Devices 18 on a data bus 16 may be coupled to the system bus 8 through the peripheral controller 14. One of the devices 18 may comprise a host processing system while the peripheral controller 14 may comprise a bridge defining the data bus 16 as a primary data bus and defining the system bus 8 as a secondary data bus. In this example, the processing platform 10 may appear as a peripheral device to such a host processing system coupled to the data bus 16. However, this is merely an example of how a processing platform may be formed as a peripheral device of a host processing system and embodiments of the present invention are not limited in this respect. For example, other embodiments may not necessarily comprise a host processing system coupled to a processor and interrupt controller through a bridge. Again, this is merely an example embodiment of a processing platform and other embodiments are not limited in this respect.

In the illustrated embodiment, the interrupt controller 4 may multiplex interrupt signals from multiple interrupt sources into interrupt signals of predefined interrupt signal types. Interrupt signals from an interrupt source associated with a first interrupt signal type may be forwarded to the processor 2 on a first interrupt input 22 and interrupt signals from an interrupt source associated with a second interrupt signal type may be forwarded to the processor 2 on a second interrupt input 24. According to an embodiment, each interrupt source may be associated with exactly one interrupt signal type. However, other embodiments of the present invention are not limited in this respect. For example, a processor may comprise one interrupt input (e.g., to respond to exactly one interrupt signal type) or more than two interrupt inputs (e.g., to respond to more than two interrupt signal types). Again, this is merely an example and other embodiments are not limited in this respect.

According to an embodiment, the processor 2 may respond to an interrupt signal on interrupt input 22 or 24 by executing an interrupt service routine stored at a predetermined location of a memory such as the RAM 26. In response to an interrupt signal, the processor 2 may retrieve an interrupt service routine memory address from a memory through the system bus 8, and then retrieve and execute instructions for the interrupt service routine from the RAM 26 at the retrieved interrupt service routine memory address. The memory to store the interrupt service routine memory address may be a memory (not shown) in the interrupt controller 4, the RAM 26 or other memory accessible through the system bus 8. However, this is merely an example of how a processor may retrieve an interrupt service routine memory address from a memory in response to an interrupt signal and embodiments of the present invention are not limited in this respect.

According to an embodiment, the processor 2 may retrieve an interrupt service routine memory address by initiating a bus transaction on the system bus 8. The processor 2 may initiate the bus transaction by, for example, generating a system bus read cycle with a valid memory address to retrieve the interrupt service routine memory address from a memory in the memory space of the processor 2 (e.g., the RAM 26 or other memory accessible through the system bus 8). In the illustrated embodiment, devices on the system bus 8 may be “chip enabled” through the address decoder 12 at unique system bus addresses. If a memory targeted for a read or write transaction is chip enabled, for example, all other devices on the system bus 8 may be disabled for this transaction. However, this is merely an example of how a processor may retrieve an interrupt service routine memory address from a memory in response to an interrupt signal and embodiments of the present invention are not limited in this respect.

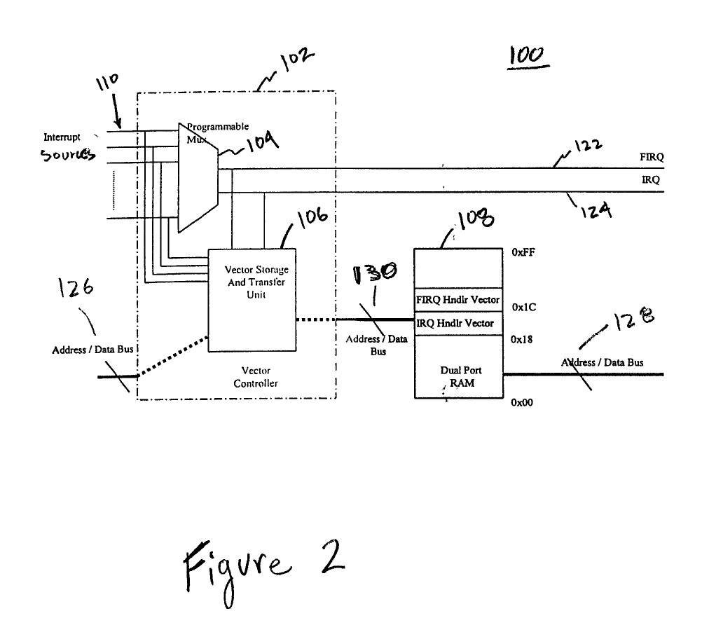

FIG. 2 shows a schematic diagram of an interrupt controller 100 according to an embodiment of the interrupt controller 4 shown in FIG. 1. The interrupt controller 100 comprises a vector controller 102 and a dual port memory 108. Interrupt controller 100 may be formed in a single semiconductor die. However, this is merely an example architecture and implementation of an interrupt controller and embodiments of the present invention are not limited in this respect.

The vector controller 102 may receive interrupt signals from any of a plurality of interrupt sources 110 and subsequently store a pre-formatted interrupt vector comprising an interrupt service routine memory address in a pre-defined location of the dual port memory 108. A processing system (not shown) may then retrieve the stored interrupt vector from the dual port memory 108, and begin executing instructions of an interrupt service routine retrieved from a memory location indicated by the interrupt service routine memory address in the interrupt vector.

The vector controller 102 comprises a multiplexer 104 and a vector storage and transfer unit (VSTU) 106. The multiplexer 104 comprises logic to associate interrupt signals from any of the interrupt sources 110 with an interrupt signal type. In the illustrated embodiment, for example, the multiplexer 104 associates interrupt signals with either an IRQ or FIRQ interrupt signal type compatible with ARM processors. The multiplexer 104 then forwards the interrupt signal to a processing system (not shown) as either an IRQ or FIRQ interrupt signal type interrupt signal depending upon the associated interrupt source 110.

It should also be understood that the presently illustrated embodiment merely shows an example of a multiplexer for use in forwarding interrupt signals of particular interrupt types to a particular processor. However, other embodiments with different processors may comprise logic to associate interrupt signals with different interrupt signal types. Also, the multiplexer 104 may associate interrupt signals from any number of interrupt sources 110. In the embodiment illustrated with reference to FIG. 2, for example, the interrupt sources 110 may comprise two distinct sets of interrupt sources such that a first set of interrupt sources is associated with a first interrupt signal type to initiates an IRQ interrupt signal type interrupt signal, and a second set of interrupt sources is associated with a second interrupt signal type to initiate an FIRQ interrupt signal type interrupt signal. However, this is merely an example of how an interrupt controller may associate each of a plurality interrupt sources with a distinct interrupt signal type and embodiments of the present invention are not limited in this respect. For example, an interrupt controller may associate interrupt sources with exactly one or more than two interrupt signal types. Again, this is merely an example embodiment and other embodiments are not limited in this respect.

In the illustrated embodiment, in response to an interrupt signal from an interrupt source 110, the VSTU 106 may comprise logic to associate the interrupt source 110 with an interrupt service routine memory address. Such logic may comprise, for example, a look up table associating each interrupt source 110 with an interrupt service routine memory address. The VSTU 106 may then store the associated interrupt service routine memory address in a location of the dual port memory 108 in response to assertion of an interrupt signal at an interrupt source 110.

According to an embodiment, the VSTU 106 may store an interrupt service routine memory address in a location of the dual port memory 108 based upon an associated interrupt signal type as determined at the multiplexer 104. For example, the VSTU 106 may receive forwarded interrupt signals 122 or 124 (e.g., depending on whether the interrupt signal asserted at an interrupt source is associated with an IRQ or FIRQ interrupt signal type) which may indicate a memory location in the dual port memory 108 to store an interrupt service routine memory address. The VSTU 106 may then store an associated interrupt service routine memory address in the dual port memory 108 at address “0×1C” if the interrupt signal is a FIRQ interrupt signal type or at address “0×18” if the interrupt signal is an IRQ interrupt signal type. In one embodiment, for example, the VSTU 106 may comprise logic to associate each interrupt source 110 with a formatted interrupt vector word and an address in the dual port memory 108 for storing the interrupt vector word (e.g., depending upon whether the interrupt source 110 generates IRQ or FIRQ type interrupt signals) in response to an interrupt signal from the interrupt source 110. However, this is merely an example of how a memory service routine memory address may be stored in a memory location based upon an underlying interrupt signal type and embodiments of the present invention are not limited in this respect.

In the presently illustrated embodiment, the dual port memory 108 comprises a first port 130 coupled to the VSTU 106 to receive and store a interrupt service routine memory address in response to an interrupt signal from an interrupt source 110, and a second port 128. According to an embodiment, the second port 128 may be coupled to a data bus such as the system bus 8 as described with reference to FIG. 1 (e.g., where the processor 2 may read from or write to the dual port memory 108 as reading from or writing to commercially available RAM). In this embodiment illustrated with reference to FIG. 1, in response to a forwarded interrupt signal 122 or 124, the processor 2 may initiate a bus transaction on the system bus 8 to retrieve the stored interrupt service routine memory address from an interrupt vector stored in the dual port memory 108, and execute an interrupt service routine from instructions located in the RAM 26 at the retrieved interrupt service routine memory address. However, this is merely an example of how an interrupt service routine memory address may be stored in a memory and the retrieved by a processor in response to an interrupt signal, and embodiments of the present invention are not limited in this respect.

According to an embodiment of the present invention, the dual port memory 108 may be addressable through the second port 128 in a bus transaction to read from or write to the dual port memory 108. In the embodiment illustrated with reference to FIG. 1, for example, the processor 2 may respond to a forwarded interrupt signal 22 or 24 by initiating a bus transaction to read data from a memory address to the dual port memory 108. The address decoder 12 may then translate the memory address in the bus transaction as a request to access the dual port memory 108 at the second port 128, and assert a dual port memory chip enable signal to the interrupt controller 100 to initiate retrieval of data from a corresponding location in the dual port memory 108 through the second port 128. In one embodiment, for example, the dual port memory 108 may comprise 256 bytes of memory in a processor's memory space addressable through the second port 128 which maps to 256 bytes of addressable memory in a processor's memory space. The address decoder 12 may then direct bus transactions to retrieve data from this portion of the processor's memory space to a corresponding memory location in the dual port memory 108 in a corresponding manner. However, this is merely an example of how a processor may initiate retrieval of an interrupt service routine memory address from a memory and embodiments of the present invention are not limited in this respect.

As discussed above, the VSTU 106 may comprise logic to associate interrupt signals from an interrupt source 110 with an interrupt service routine memory address to be stored in the dual port memory 108. According to an embodiment, the VSTU 106 may comprise the logic to associate particular interrupt sources with interrupt service routine memory addresses and may be programmable through a port 126. In an embodiment illustrated in FIG. 1, for example, the port 126 may be coupled to the system bus 8 such that the logic in VSTU 106 may be updated through a bus transaction on the system bus 8. Such a bus transaction may be initiated by, for example, a process hosted on a host processing system coupled to the system bus 8 through the peripheral controller 14. The multiplexer 104 may also comprise logic to associate various interrupt sources with interrupt signals 122 and 124 (e.g., corresponding with distinct interrupt signal types) and may be programmable through the port 126. However, these are merely examples of programming logic to associate interrupt sources with interrupt service routine memory addresses and embodiments of the present invention are not limited in this respect.

The interrupt controller 100 may be configurable during a power up procedure. For example, such a procedure may initialize the multiplexer 104 to transmit interrupt signals 122 or 124 in response to interrupt signals asserted at interrupt sources 100. Such a procedure may also program the VSTU 106to contain predetermined values to be written in the dual port RAM 108 when a particular interrupt source 110 asserts an interrupt signal. Accordingly, an associated processing system (not shown) receiving an asserted interrupt signal 122 or 124 may retrieve interrupt vector data from corresponding locations in the dual port memory 108. This may enable the processing system to jump directly to the appropriate interrupt service routine, bypassing any intermediate software routine for locating the correct interrupt service routine. However, this is merely an example of an implementation of an interrupt controller and embodiments of the present invention are not limited in this respect.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
receiving an interrupt signal from one of a plurality of interrupt sources;
associating the interrupt source with an interrupt service routine memory address, the interrupt service routine memory address indicating a memory location in a first memory;
storing the interrupt service routine memory address at a memory location in a second memory; and
initiating execution of instructions stored in the first memory at a memory address retrieved from the memory location of the second memory in response to the interrupt signal.

2. The method of claim 1, the method further comprising storing the interrupt service routine memory address in the second memory.

3. The method of claim 1, the method further comprising:
associating a first set of the interrupt sources with a first interrupt signal type; and
associating a second set of the interrupt sources with a second interrupt signal type, the first set of interrupt sources being distinct from the second set of interrupt sources.

4. The method of claim 3, the method further comprising:
storing an interrupt service routine memory address in the second memory at a memory address associated with the first interrupt signal type in response to an interrupt signal asserted at one of the first set of interrupt sources; and
retrieving the interrupt service routine memory address stored in the second memory at the memory address associated with the first interrupt signal type in response to the asserted interrupt signal.

5. The method of claim 4, the method further comprising:
storing an interrupt service routine memory address in the second memory at a memory address associated with the second interrupt type in response to an interrupt signal from one of the second set of interrupt sources; and
retrieving the memory address stored in second memory at the memory address associated with the first interrupt signal in response to the interrupt signal from the interrupt source of the second set of interrupt sources.

6. The method of claim 1, the method further comprising:
storing the interrupt service routine memory address in the second memory through a first port of the second memory; and
retrieving the interrupt service routine memory address through a second port of the second memory.

7. The method of claim 1, the method further comprising:
associating each of the interrupt sources with one or more sets of interrupt sources;
associating each set of interrupt sources with an interrupt signal type, each set of interrupt sources being distinct from any other set of interrupt sources.

8. The method of claim 7, the method further comprising:
storing an interrupt service routine memory address in the second memory at a memory address associated with a particular interrupt signal type in response to an interrupt signal asserted at a particular interrupt source, the particular interrupt source being in a set of interrupt sources associated with the particular interrupt signal type; and
retrieving the interrupt service routine memory address stored in the second memory at the memory address associated with the particular interrupt signal type in response to the asserted interrupt signal.

9. An interrupt controller comprising:
a circuit adapted to receive interrupt signals from a plurality of interrupt sources;
logic to associate an interrupt signal from one of the plurality of sources with an interrupt service routine memory address;
logic to store the interrupt service routine memory address in a location of a memory accessible by a processor; and
logic to forward the interrupt signal to the processor.

10. The interrupt controller of claim 9, wherein the interrupt controller further comprises logic to output the interrupt service routine memory address from the memory in response to a bus transaction initiated by the processor.

11. The interrupt controller of claim 9, the interrupt controller further comprising:
logic to associate a first set of the interrupt sources with a first interrupt signal type; and
logic to associate a second set of the interrupt sources with a second interrupt signal type, the first set of interrupt sources being distinct from the second set of interrupt sources.

12. The interrupt controller of claim 11, the interrupt controller further comprising logic to store an interrupt service routine memory address in the memory at a memory address associated with the first interrupt signal type in response to an interrupt signal asserted at one of the first set of interrupt sources.

13. The interrupt controller of claim 12, the interrupt controller further comprising logic to store an interrupt service routine memory address in the memory at a memory address associated with the second interrupt signal type.

14. The interrupt controller of claim 9, the interrupt controller further comprising:
logic to store the interrupt service routine memory address in the memory through a first port of the memory; and
logic to output the interrupt service routine memory address through a second port of the memory.

15. The interrupt controller of claim 9, the interrupt controller further comprising:
logic to associate each of the interrupt sources with one or more sets of interrupt sources; and
logic to associate each set of interrupt sources with an interrupt signal type, each set of interrupt sources being distinct from any other set of interrupt sources.

16. The interrupt controller of claim 15, the interrupt controller further comprising:
logic to store an interrupt service routine memory address in the memory at a memory address associated with a particular interrupt signal type in response to an interrupt signal asserted at a particular interrupt source, the particular interrupt source being in a set of interrupt sources associated with the particular interrupt signal type; and
logic to retrieve the interrupt service routine memory address stored in the memory at the memory address associated with the particular interrupt signal type in response to the asserted interrupt signal.

17. A system comprising:
a processor;
a data bus; and
an interrupt controller coupled to the processor through the data bus, the interrupt controller comprising:
a circuit adapted to receive interrupt signals from a plurality of interrupt sources;
logic to associate an interrupt signal from one of the plurality of sources with an interrupt service routine memory address;
logic to store the interrupt service routine memory address in a location of a memory accessible by the processor; and
logic to forward the interrupt signal to the processor.

18. The system of claim 17, wherein the interrupt controller further comprises a dual port memory and logic to store the interrupt service routine memory address in a location of the memory through a first port, and wherein the interrupt service routine memory address is retrievable from the dual port memory through a second port in response to a bus transaction on the data bus.

19. The system of claim 17, wherein the system further comprises a host processing system coupled to the data bus, and wherein the host processing system comprises logic to initiate a bus transaction on the data bus to program the interrupt controller to associate an interrupt signal from one of the plurality of sources with an interrupt service routine memory address.

20. The system of claim 17, wherein the interrupt controller further comprises logic to output the interrupt service routine memory address from the memory in response to a bus transaction initiated by the processor.

21. The system of claim 17, wherein the interrupt controller further comprises:
logic to associate a first set of the interrupt sources with a first interrupt signal type; and
logic to associate a second set of the interrupt sources with a second interrupt signal type, the first set of interrupt sources being distinct from the second set of interrupt sources.

22. The system of claim 21, wherein the interrupt controller further comprises logic to store an interrupt service routine memory address in the memory at a memory address associated with the first interrupt signal type in response to an interrupt signal from one of the first set of interrupt sources.

23. The system of claim 22, wherein the interrupt controller further comprises logic to store an interrupt service routine memory address in the memory at a memory address associated with the second interrupt signal type.

24. The system of claim 17, wherein the interrupt controller further comprises:
logic to store the interrupt service routine memory address in the memory through a first port of the memory; and
logic to output the interrupt service routine memory address through a second port of the memory.

25. The system of claim 17, wherein the interrupt controller further comprises:
logic to associate each of the interrupt sources with one or more sets of interrupt sources; and
logic to associate each set of interrupt sources with an interrupt signal type, each set of interrupt sources being distinct from any other set of interrupt sources.

26. The system of claim 25, wherein the interrupt controller further comprises:
logic to store an interrupt service routine memory address in the memory at a memory address associated with a particular interrupt signal type in response to an interrupt signal asserted at a particular interrupt source, the particular interrupt source being in a set of interrupt sources associated with the particular interrupt signal type; and
logic to retrieve the interrupt service routine memory address stored in the memory at the memory address associated with the particular interrupt signal type in response to the asserted interrupt signal.

27. An apparatus comprising:
means for receiving an interrupt signal from one of a plurality of interrupt sources;
means for associating the interrupt source with an interrupt service routine memory address, the interrupt service routine memory address indicating a memory location in a first memory;
means for storing the interrupt service routine memory address at a memory location in a second memory; and
means for initiating execution of instructions stored in the first memory stored at a memory address retrieved from the memory location of the second memory in response to the interrupt signal.

28. The apparatus of claim 27, the apparatus further comprising means for storing the interrupt service routine memory address in the second memory.

29. The apparatus of claim 27, the apparatus further comprising:
means for associating a first set of the interrupt sources with a first interrupt signal type; and
means for associating a second set of the interrupt sources with a second interrupt signal type, the first set of interrupt sources being distinct from the second set of interrupt sources.

30. The apparatus of claim 29, the apparatus further comprising:
means for storing an interrupt service routine memory address in the second memory at a memory address associated with the first interrupt signal type in response to an interrupt signal from one of the first set of interrupt sources; and
means for retrieving the interrupt service routine memory address stored in second memory at the memory address associated with the first interrupt signal type in response to the interrupt signal from the interrupt source of the first set of interrupt sources.

31. The apparatus of claim 30, the apparatus further comprising:
means for storing an interrupt service routine memory address in the second memory at a memory address associated with the second interrupt signal type in response to an interrupt signal from one of the second set of interrupt sources; and
means for retrieving the memory address stored in second memory at the memory address associated with the first interrupt signal type in response to the interrupt signal from the interrupt source of the second set of interrupt sources.

32. The apparatus of claim 27, the apparatus further comprising:
means for storing the interrupt service routine memory address in the second memory through a first port of the second memory; and
means for retrieving the interrupt service routine memory address through a second port of the second memory.

33. The apparatus of claim 27, the apparatus further comprising:
means for associating each of the interrupt sources with one or more sets of interrupt sources; and
means for associating each set of interrupt sources with an interrupt signal type, each set of interrupt sources being distinct from any other set of interrupt sources.

34. The apparatus of claim 33, the apparatus further comprising:
means for storing an interrupt service routine memory address in the second memory at a memory address associated with a particular interrupt signal type in response to an interrupt signal asserted at a particular interrupt source, the particular interrupt source being in a set of interrupt sources associated with the particular interrupt signal type; and
means for retrieving the interrupt service routine memory address stored in the second memory at the memory address associated with the particular interrupt signal type in response to the asserted interrupt signal.
